(19) United States
(12) Patent Application Publication
(10) Pub. No.: US 2002/0174903 A1
(43) Pub. Date: Nov. 28, 2002

(54) Valve and water dispenser

(75) Inventor: Ian Edwin Sparrowhawk, Wheeler End Common (GB)

Correspondence Address: Patterson, Thuente, Skaar & Christensen. P.A., 4800 IDS Center, 80 South 8th Street, Minneapolis, MN, 55402-2100, US

(73) Assignee: Beta Valve Systems Ltd.

(21) Appl. No.: 10/102,987

(22) Filed: Mar. 21, 2002

Related U.S. Application Data
(63) Continuation of application No. PCT/GB00/03627, filed on Sep. 21, 2000.

(30) Foreign Application Priority Data
Sep. 21, 1999 (GB) 9922355.4
Feb. 8, 2000 (GB) 0002853.0

(51) Int. Cl. F16K 11/04

(52) U.S. Cl. 137/589

(57) ABSTRACT

A liquid dispenser, for example a vending machine, includes a valve intermediate a reservoir and an outlet tube. The valve includes a vent port which is opened when the valve is closed to allow the outlet tube to drain quickly and neatly.

The invention relates to a valve, in particular a valve for a water dispenser.

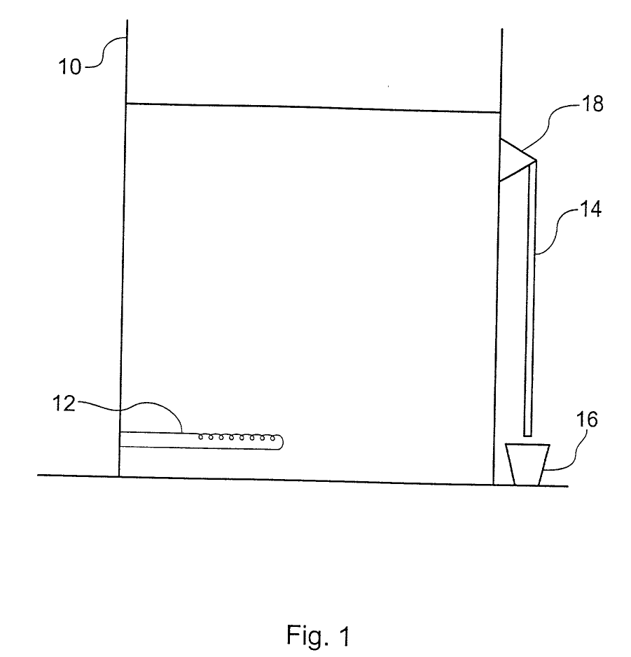

A known type of water dispenser of the type generally termed a vending machine is shown in FIG. 1. Water is stored in a tank 10 and heated by an element 12 of any suitable type. A heated water outlet pipe 14 runs down to a cup station 16. Water flow is controlled by a valve 18 intermediate with the pipe 14 and the container or tank 10.

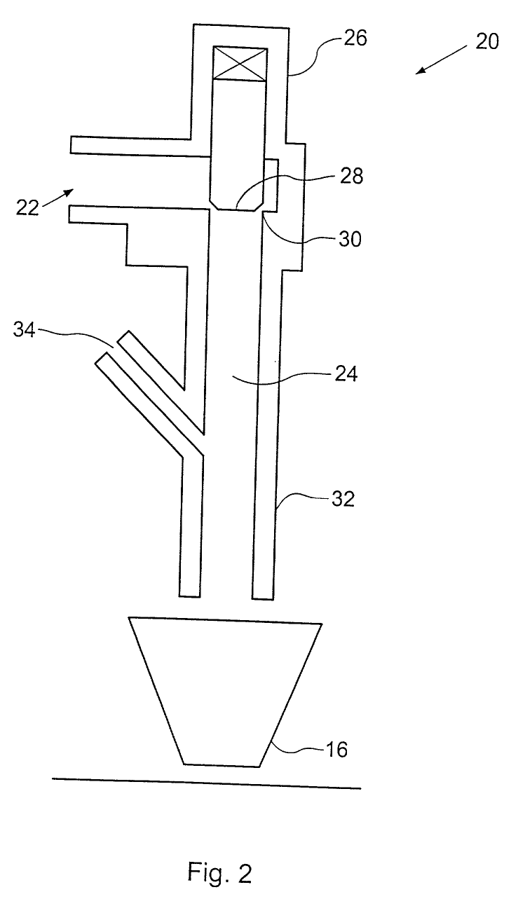

A conventional valve used in a known system is shown in FIG. 2. The valve 20 includes an inlet 22, an outlet 24 leading to a down tube 32 and a valve actuator 26. The valve actuator can be of any appropriate type for example a solenoid driven valve actuator and includes a valve member 28 which engages a seat 30 intermediate the inlet and outlet 22, 24 respectively. The valve is actuated to open and close the outlet 24. A known problem with such systems arises when the valve is closed at which point water must drain from the down tube 32. Without additional venting arrangements an air-lock is formed and the down tube 32 will drain very slowly. In the arrangement shown in FIG. 2, therefore, an active vent 34 is provided. Such an arrangement requires a large valve outlet/down tube to ensure that the valve has authority, i.e. the relevant level of back pressure is generated for the vent 34 to operate in the correct manner. In addition the vent pipe itself is of course an additional manufacturing requirement. Yet further, adapters are generally required to accommodate the increased inner diameters required by such a system. In additional to the general bulk of the known valves, the stroke of the solenoid valve actuator is also longer requiring correspondingly larger and stronger components. The overall effect is that the size and cost of the arrangement is greatly increased.

In another known arrangement a vent port is provided in the valve armature tube and closed by the armature when the valve is opened. However this arrangement is prone to contamination and leakage, requiring a further separate vent pipe, because of water contact with the armature and egress into the vent.

A further problem with known arrangements is the build-up of deposits on and around the valve seat which necessitates frequent maintenance of known dispensers.

The invention is set out in the appended claims and the advantages attached to the invention will be clear from the following description.

According to one embodiment, there is preferably provided a valve, including a seat which is substantially vertically disposed; a valve outlet port being provided substantially vertically below the valve seat. The inclination of the valve seat means that gravity acts to urge deposits on and around the valve seat down to, and out of, the outlet. Further, deposits from the valve seat tend to be flushed down and out the outlet when the dispenser is in use.

Embodiments of the invention will now be described, by way of example, with reference to the drawings of which:

FIG. 1 is a schematic view showing a known water dispenser;

FIG. 2 is a partially sectional view showing a valve for a water dispenser of a known type;

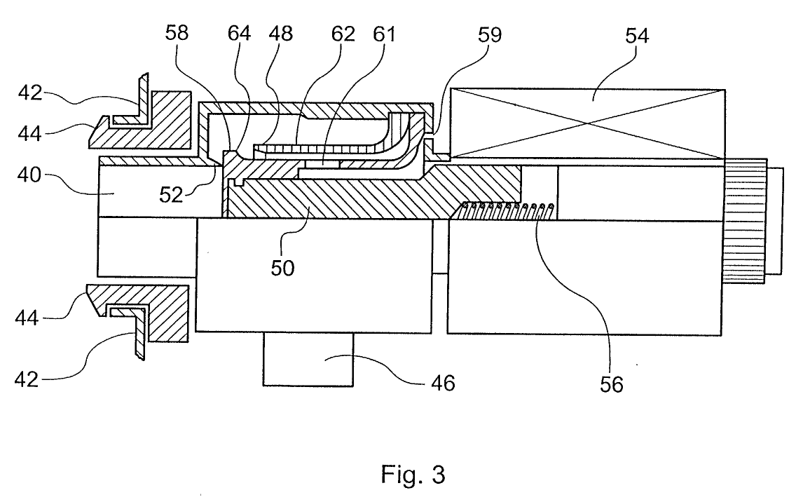

FIG. 3 shows a valve in partial sectional view according to the present invention;

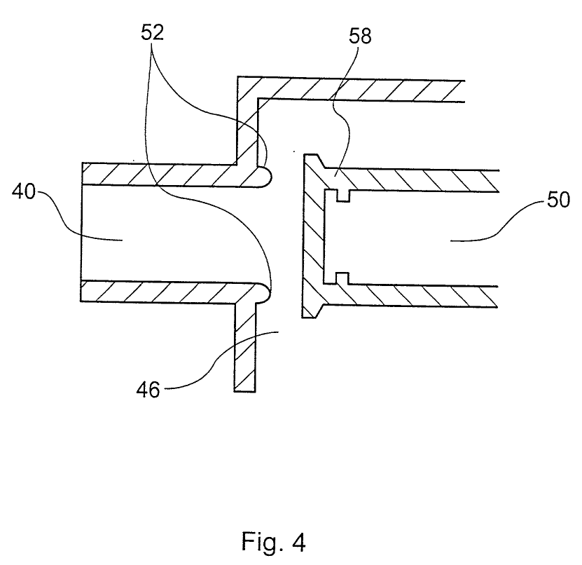

FIG. 4 shows part of the valve of FIG. 3 in a partial sectional view;

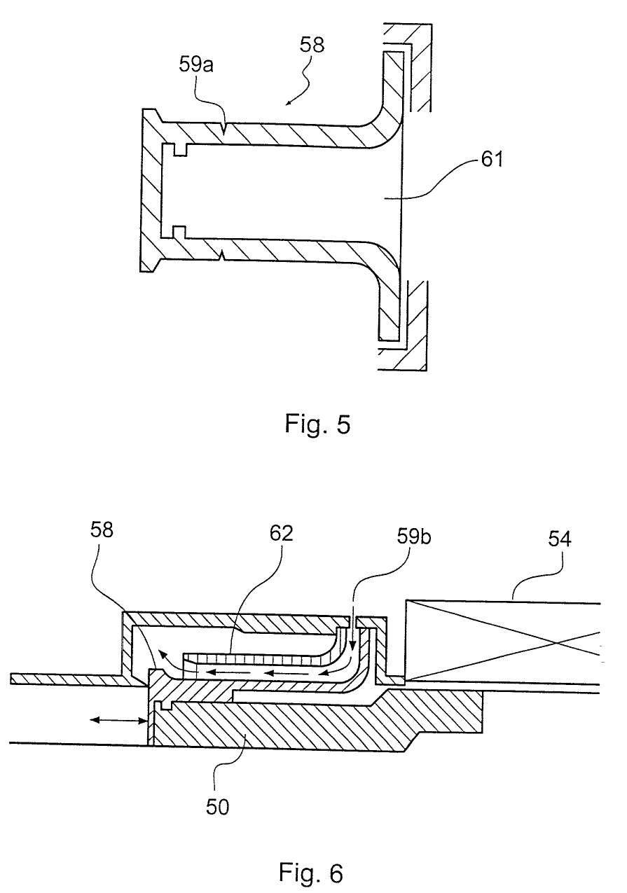

FIG. 5 shows a part sectional view of a seal of the present invention; and

FIG. 6 shows an alternative configuration.

Referring to FIG. 3 a valve according to the present invention includes an inlet port 40 sealed to the wall of a water tank 42 by an appropriate sealing plug 44. The valve further includes an outlet port 46 and a vent port 48. A valve armature 50 is driven into and out of engagement with a valve seat 52 of inlet 40 by a solenoid 54 of known type, or any other suitable means.

FIG. 4 shows the armature in the open position when drawn back away from the valve seat 52. The valve seat 52 is in a vertical plane, which offers the advantage that build up of deposits such as calcium, for example around the valve seat, is minimised. This is because such deposits are urged downwards to, and out of, the outlet 46 by gravity, and/or tend to be flushed or precipitated downwards by the flow of water from the inlet 40 to vertically disposed outlet 46. The valve thus requires less frequent maintenance.

As shown by the further detail of FIG. 4, the outlet is preferably provided directly below the valve seat 52.

The armature 50 is preferably spring loaded by a spring 56, biased to the closed position. The armature 50 further includes a resilient seal 58. The resilient seal 58 comprises a cylindrical cover around the armature 50. The seal is attached to the valve wall, allowing the armature 50 to remain dry, increasing its working life and reducing contamination. The seal allows communication with an air vent 59 in the valve wall via an aperture 61 in the seal to the outlet port 46.

The aperture 61 comprises a hole as shown in FIG. 3. In a variation of this embodiment, however, the aperture comprises a V-shaped slit 59a (or a number of such slits for example three equidistant about the circumference) in the resilient seal 58 as shown in FIG. 5. The operation of the slit or slits allows air to pass to vent water, and acts as a non-return valve, effectively being a second barrier (after the valve seal) to prevent water ingress into the armature. Alternatively the slit can be a simple slit or any other appropriate type of one-way valve.

The air path is via an annular opening formed by a further cylindrical sheath formation 62 surrounding the seal 58. The vent port 48 is formed by the annular opening between the cylindrical formation 62 and the seal 58. The seal 58 includes a portion 64 of increased diameter arranged to engage the cylindrical formation in a closed position to close the vent port. In the valve-closed position shown, the vent port 48 is in an open position. As a result air can freely enter the valve through vent hole 59 and aperture 61 allowing water to drain from the outlet 46 via any appropriate down tube (not shown). When the valve is in the open position and the valve armature 50 is retracted, water can flow through the valve through inlet 40. At the same time the seal 58 is drawn back, closing the vent port 48. Accordingly when the water dispenser is used, the valve 50 opens to allow heated water to flow through the tube. The valve is then closed to cut off flow and at the same time the vent port 48 is opened allowing the down tube to vent the remaining hot water quickly, efficiently and neatly.

In yet another alternative shown in FIG. 6 the air vent 59b is provided in the wall of the valve between the cylindrical sheath 62 and the seal 58. As a result the integrity of the seal is not affected at all, providing an entirely dry armature in all circumstances. An up-pipe from the vent 59b (not shown) can reduce the risk of leakage yet further.

As a result of this system a greatly reduced internal diameter can be achieved in the inlet and outlet, for example 11.5 millimeters. This can remove the need for internal diameter adapters. In addition a solenoid providing a much smaller stroke can be used, reducing the costs and size of the arrangement as a whole. Accordingly many problems associated with known arrangements are overcome. A dry armature is provided, and all ports are incorporated in the body of the valve. The sequence of operation, “vent after vend” is also advantageous.

It will be appreciated that the various components can individually be of known type and of any appropriate material. The arrangement can of course be used for other liquids than water. The valve can be actuated by any appropriate means, for example a solenoid operated valve as is well known.

1. A valve comprising a liquid inlet port, a liquid outlet port, a vent port, a valve armature and an armature sheath, the vent port being formed between the armature and the sheath and the valve armature being actuable to simultaneously close the inlet port and open the vent port or vice versa.

2. A valve as claimed in claim 1 in which the valve armature is solenoid actuated.

3. A valve as claimed in claim 1 or 2 in which the valve armature is arranged to engage a valve seat associated with the inlet port.

4. A valve as claimed in claim 3 in which the valve seat is substantially vertically disposed.

5. A valve as claimed in claim 3 or claim 4 in which the outlet port is provided substantially vertically below the valve seat.

6. A valve as claimed in any one of claims 3 to 5 in which the sheath comprises a cylindrical formation surrounding the armature.

7. A valve as claimed in any one of the preceding claims in which a vented seal is formed around the armature, including a vent path to the vent port.

8. A valve as claimed in claim 7 in which the seal is vented by means of a slit.

9. A valve as claimed in claim 7 in which the seal is vented by means of three V-shaped slits.

10. A valve as claimed in any of claims 1 to 6 in which a seal is formed around the valve armature and the vent port is vented to atmosphere via a vent inlet intermediate the sheath and the armature seal.

11. A liquid dispenser comprising a liquid reservoir, a liquid outlet and a valve therebetween, as claimed in any preceding claim, the valve inlet port communicating with the reservoir and the valve outlet port communicating with the liquid outlet.

12. A liquid dispenser comprising a liquid reservoir, a liquid outlet and a valve therebetween as claimed in any preceding claim, the valve including a substantially vertically disposed valve seat, the outlet being provided substantially vertically below the valve seat.

13. An armature assembly for a valve comprising an armature, a seal around the armature, and a vent path formed between the arm and the seal, in which the seal includes a one-way valve means for venting from the vent path into the seal.

14. An armature as claimed in claim 13 in which the valve means is a resilient slit, for example a V-shaped slit.

15. A valve including an armature as claimed in claim 13 or claim 14.

16. A valve comprising a valve body having a liquid inlet port and a liquid outlet port and an air vent inlet, the valve further comprising a dry valve armature and a vent port communicating with the vent inlet via a vent path, and closable by the armature, the vent path being formed external to the dry armature.

17. A valve comprising a valve body including a liquid inlet, a liquid outlet, and a valve seat therebetween; a vent port communicating with the inlet via a vent port, and a dry valve armature selectively engageable with the valve seat to regulate a liquid flow down the outlet; in which the valve seat is substantially vertically disposed.

18. A valve, dispenser or armature substantially as specifically described herein and as illustrated in FIG. 3 to FIG. 6.
